(19) United States
(12) Patent Application Publication
(10) Pub. No.: US 2011/0170776 A1
(43) Pub. Date: Jul. 14, 2011

(54) IMAGE DISTORTION CORRECTING METHOD AND IMAGE PROCESSING APPARATUS

(76) Inventors: Shigeyuki Ueda, Tokyo (JP); Hideki Tsuboi, Tokyo (JP)

(21) Appl. No.: 13/119,303

(22) PCT Filed: Sep. 15, 2009
(86) PCT No.: PCT/JP2009/066081

§ 371 Date: Mar. 16, 2011

(30) Foreign Application Priority Data
Sep. 19, 2008 (JP) 2008-240425

(51) Int. Cl. G06K 9/00; G06K 9/40

(52) U.S. Cl. 382/167; 382/275

(57) ABSTRACT

An image processing apparatus is provided which makes it possible to improve an access speed for accessing a storage device so as to improve an image processing velocity without increasing a capacity of the storage device. The apparatus includes an optical system; an imaging device having a plurality of pixels each corresponding to one of colors and an arithmetic calculating section to process image data. When a color of an original pixel is different from that of a distortion-corrected pixel, the arithmetic calculating section conducts an interpolation processing to calculate pixel data of the distortion-corrected pixel from other pixel data of plural pixels residing at peripheral positions surrounding the original pixel, stored in advance, and the arithmetic calculating section stores pixel data categorized in one of the colors as a continuous series of the pixel data into corresponding one of storing areas provided in the storage section.

### FIELD OF THE INVENTION

The present invention relates to an image distortion correcting method to be employed in a correction processing for correcting a distortion of an image captured by an image capturing element (hereinafter, also referred to as an imaging device or an imager) through an optical system, and an image processing apparatus of the same.

### TECHNICAL BACKGROUND

Conventionally, in the imaging device, such as a CCD (Charge Coupled Device) imager, a CMOS (Complementary Metal-Oxide Semiconductor) imager, etc., pixels are physically arranged in the Bayer arrangement structure as shown in FIG. 1. When the imaging device employs the Bayer arrangement structure as shown in FIG. 1, for instance, the image data outputted by the imaging device as shown in FIG. 2a is stored into a storage device (memory) of an image processing apparatus in the form of continuous serial data as shown in FIG. 2b (for instance, refer to Patent Document 1).

### PRIOR ART REFERENCE

### Patent Document

Patent Document 1: Specification of Japanese Patent No. 3395195

### SUMMARY OF THE INVENTION

### Subject to be Solved by the Invention

Prior to the present invention, one of the present inventors has set forth in Tokkai 2009-157733 (Japanese Patent Application Laid-Open Publication) such a technique that, for instance, when the R (Red color) image data is found from image data in regard to all of the pixels arranged in the Bayer arrangement structure, the R image data for all of the pixels is found by applying the color separation interpolation processing as shown in FIGS. 4b through 4d. However, in the case that such the color separation interpolation processing as shown in FIGS. 4b through 4d is performed, since data sets of R1-R4 (R21, R23, R41, R43) are stored in the positions being separate from each other as shown in FIG. 2b, there has been such a drawback that the standby waiting time, caused by the access time, increases when they are read from the storage device (memory). In order to achieve the high speed accessing operation, the image data sets of all pixels as shown in FIG. 2a are grouped into three groups as shown in FIGS. 3a through 3c, each of which corresponds to each of the RGB primary colors, so as to make the high speed accessing operation possible. However, since it becomes necessary to introduce a new process for sorting the image data sets with respect to each of the RGB primary colors, there has also arisen various kinds of demerits, such as a deterioration of the processing velocity, a cost increase due to the increase of the working area capacity in the storage device, an increase of the power consumption, a high rate heat generation, a growth of apparatus size, etc., and such the demerits have overridden the merit of improving the accessing speed abovementioned.

In view of the problems in the conventional technologies, an object of the present invention is to provide an image distortion correcting method and an image processing apparatus, each of which makes it possible to improve the access speed for accessing the storage device so as to improve the image processing velocity without increasing the storage capacity of the storage device concerned.

### Means for Solving the Subject

As abovementioned, when the color separation interpolation processing is conducted, it is beneficial for shortening the processing time that the pixel data sets to be used are stored in the same storage area of the storage device concerned. When the color separation interpolation processing is conducted with respect to the primary color family arrangement structure (Bayer arrangement structure) as shown in FIG. 1, the interpolation processing is performed by finding a data averaging value of a plurality of peripheral pixels. Accordingly, it becomes possible to shorten the processing time by storing the plurality of peripheral pixels to be used for finding the data averaging value into the same storage area. Further, when the color separation interpolation processing is conducted with respect to the complimentary color family arrangement structure, since the interpolation processing includes an addition processing and a subtraction processing, and each of these data sets is also found from an averaging value of a plurality of data sets, it becomes possible to conduct the high speed processing, by storing them into the same storage area.

Concretely speaking, in order to achieve the abovementioned object of the present invention, an image distortion correcting method, provided with an imaging device that is provided with a plurality of pixels, each of which corresponding to one of colors, for correcting a distortion of an image captured by the imaging device through an optical system, is characterized in that: when the colors of a pixel are different from each other before and after a distortion correcting operation, pixel data after the distortion correcting operation is acquired by the interpolation processing by the pixel data of plural pixels around the pixel before the distortion correcting operation, pixel data of which after the distortion correcting operation has been stored in a memory; and pixel data of the same color are continuously stored in the memory for every color.

According to the image distortion correcting method described in the above, by continuously storing the pixel data of the same color into the memory for every color, it becomes possible to conduct the high speed accessing operation into the memory, and as a result, it becomes possible to improve the memory accessing speed without increasing the memory capacity, resulting in an improvement of the image processing velocity.

Namely, in order to achieve the abovementioned object of the present invention, an image distortion correcting method, provided with an imaging device that is provided with a plurality of pixels, each of which corresponding to one of colors, for correcting a distortion of an image captured by the imaging device through an optical system, is characterized in that: pixel data after the distortion correcting operation, a color of which is same as a color before the distortion correcting operation, is acquired by the interpolation processing by the pixel data of plural pixels around the pixel before the distortion correcting operation, which has been stored in a memory; pixel data of the same color are continuously stored in the memory for every color.

According to the image distortion correcting method described in the above, by continuously storing the pixel data of the same color into the memory for every color, it becomes possible to conduct the high speed accessing operation into the memory, and as a result, it becomes possible to improve the memory accessing speed without increasing the memory capacity, resulting in an improvement of the image processing velocity.

In the image distortion correcting method, described in the above, it is preferable that the interpolation processing includes: a first processing in which, when a color of pixel arranged at a predetermined position within a peripheral space of the pixel before the distortion correcting operation is same as that of the pixel after the distortion correcting operation, pixel data of the pixel arranged at the predetermined position is used as it is, while, when being different from that of the pixel after the distortion correcting operation, being acquired by interpolating the pixel arranged at the predetermined position with pixel data of plural pixels around its peripheral space, the color of the plural pixels being same as that after the distortion correcting operation; and a second processing in which the pixel data after the distortion correcting operation is acquired by interpolating with a relative positional relationship between a position of the pixel before the distortion correcting operation and the pixel arranged at the predetermined position, and the pixel data of the plural pixels arranged at the predetermined positions acquired in the first processing.

In the image distortion correcting method, described in the above, it is preferable that the largeness of one block unit of a memory area into which the pixel data is continuously stored for every color is secured to be larger than a unit of the plural pixels to be employed for the interpolation processing. For instance, when the interpolation processing is conducted by employing the pixel data of the four pixels residing at the peripheral positions in the vicinity of the predetermined pixel, it is preferable that the capacity of the memory area in a unit of one block is greater than that of storing pixel data of four pixels.

Further, it is preferable that, when the plural colors includes a color to be used for calculating RGB, an operation for storing pixel data after the distortion correcting operation into the memory is conducted in such a manner that pixel data of colors to be employed for calculating the RGB is continuously conducted.

According to an image processing apparatus embodied in the present invention, the image processing apparatus that is provided with: an optical system; an imaging device that is provided with a plurality of pixels, each of which corresponds to one of colors, and captures an image through the optical system; an arithmetic calculating apparatus for processing the image acquired from the imaging device; and a memory, is characterized in that, in a processing for correcting a distortion of the image, the arithmetic calculating apparatus calculates pixel data after the distortion correcting operation, a color of which is same as a color before the distortion correcting operation, by the interpolation processing by the pixel data of plural pixels around the pixel before the distortion correcting operation, which has been stored in a memory, and continuously stores pixel data of the same color in the memory for every color.

According to the image processing apparatus described in the above, by continuously storing the pixel data of the same color into the memory for every color, it becomes possible to conduct the high speed accessing operation into the memory, and as a result, it becomes possible to improve the memory accessing speed without increasing the memory capacity, resulting in an improvement of the image processing velocity.

In the image processing apparatus described in the above, it is preferable that the arithmetic calculating apparatus conducts the interpolation processing by: a first processing in which, when a color of pixel arranged at a predetermined position within a peripheral space of the pixel before the distortion correcting operation is same as that of the pixel after the distortion correcting operation, pixel data of the pixel arranged at the predetermined position is used as it is, while, when being different from that of the pixel after the distortion correcting operation, being acquired by interpolating the pixel arranged at the predetermined position with pixel data of plural pixels around its peripheral space, the color of the plural pixels being same as that after the distortion correcting operation; and a second processing in which the pixel data after the distortion correcting operation is acquired by interpolating with a relative positional relationship between a position of the pixel before the distortion correcting operation and the pixel arranged at the predetermined position, and the pixel data of the plural pixels arranged at the predetermined positions acquired in the first processing.

In the image processing apparatus, described in the above, it is preferable that the largeness of one block unit of a memory area into which the pixel data is continuously stored for every color is secured to be larger than the size of a unit of the plural pixels to be employed for the interpolation processing. For instance, when the interpolation processing is conducted by employing the pixel data of the four pixels residing at the peripheral positions in the vicinity of the predetermined pixel, it is preferable that the capacity of the memory area in a unit of one block is greater than that of storing pixel data of four pixels.

Further, it is preferable that, when the plural colors includes a color to be used for calculating RGB, an operation for storing pixel data after the distortion correcting operation into the memory is conducted in such a manner that pixel data of colors to be employed for calculating the RGB is continuously conducted.

Still further, when the optical system is a wide angle use optical system, it is possible to correct a distortion included in the image captured through the wide angle use optical system.

In this connection, an image forming apparatus, embodied in the present invention, is provided with both the image processing apparatus, described in the foregoing, and an image processing section that separately conducts image processing operations other than those to be conducted by the image processing apparatus abovementioned. Therefore, according to the image forming apparatus abovementioned, by outputting the image data, to which the aforementioned image-distortion correction processing has been applied, to the image processing section, it becomes possible to complete the image distortion correction processing, before the image processing, such as an ISP (Image Signal Processing), etc., is applied to the image data concerned. As a result, it becomes possible to acquire the distortion corrected image more natural than ever.

### Effect of the Invention

According to the present invention, it becomes possible to provide an image distortion correcting method and an image processing apparatus, each of which makes it possible to improve the access speed for accessing the storage device so as to improve the image processing velocity without increasing the storage capacity of the storage device concerned.

### BRIEF DESCRIPTION OF THE DRAWINGS

FIG. 1 is a schematic diagram, schematically indicating a Bayer arrangement structure of general purpose in a raw image captured by an imaging device.

FIG. 2a is a schematic diagram schematically indicating pixel data outputted from an imaging device, when the Bayer arrangement structure is employed in the imaging device concerned, while, FIG. 2a is a schematic diagram schematically indicating pixel data to be stored in the storage device (memory) in a form of continuous serial row.

FIG. 3a is a schematic diagram schematically indicating a storage area into which pixel data sets of R (Red) are stored from pixel data sets shown in FIG. 2a; FIG. 3b is another schematic diagram schematically indicating another storage area into which pixel data sets of G (Green) are stored from pixel data sets shown in FIG. 2a; and FIG. 3c is another schematic diagram schematically indicating another storage area into which pixel data sets of B (Blue) are stored from pixel data sets shown in FIG. 2a.

FIG. 4a, FIG. 4b, FIG. 4c and FIG. 4d are explanatory schematic diagrams, indicating peripheral pixels to be used for an interpolation calculation processing, when a color of a distortion corrected pixel is R (Red), and for explaining four cases including: case (a), in which a color of a pixel, before an interpolation processing is applied, is “R” (Red), and “R” is replaced with “R” (“R”→“R”); case (b), in which a color of a pixel, before an interpolation processing is applied, is “B” (Blue), and “B” is replaced with “R” (“B”→“R”); case (c), in which a color of a pixel, before an interpolation processing is applied, is “_{odd}G” (odd Green), and “_{odd}G” is replaced with “R” (“_{odd}G”→“R”); and case (d), in which a color of a pixel, before an interpolation processing is applied, is “ₑᵥₑₙG” (even Green), and “ₑᵥₑₙG” is replaced with “R” (“ₑᵥₑₙG”→“R”), respectively, in the present embodiment.

FIG. 5a, FIG. 5b, FIG. 5c and FIG. 5d are explanatory schematic diagrams, indicating peripheral pixels to be used for the interpolation calculation processing, when a color of a distortion corrected pixel is B (Blue), and for explaining four cases including: case (a), in which a color of a pixel, before an interpolation processing is applied, is “B” (Blue), and “B” is replaced with “B” (“B”→“B”); case (b), in which a color of a pixel, before an interpolation processing is applied, is “R” (Red), and “R” is replaced with “B” (“R”→“B”); case (c), in which a color of a pixel, before an interpolation processing is applied, is “_{odd}G” (odd Green), and “_{odd}G” is replaced with “B” (“_{odd}G”→“B”); and case (d), in which a color of a pixel, before an interpolation processing is applied, is “ₑᵥₑₙG” (even Green), and “ₑᵥₑₙG” is replaced with “B”→“B”), respectively, in the present embodiment.

FIG. 6a and FIG. 6b are explanatory schematic diagrams, indicating peripheral pixels to be used for an interpolation calculation processing, when a color of a distortion corrected pixel is G (Green), and for explaining two cases including: case (a), in which a color of a pixel, before an interpolation processing is applied, is “G” (Green), and “G” is replaced with “G” (“G”→“G”); and case (b), in which a color of a pixel, before an interpolation processing is applied, is “R” (Red) or “B” (Blue), other than “G” (Green), and “R” or “B” is replaced with “G” (other than “G”→“G”), in the present embodiment.

FIG. 7a is an explanatory schematic diagram for explaining an image before an image distortion correction operation is applied in the embodiment of the present invention, while, FIG. 7b is an explanatory schematic diagram for explaining another image after an image distortion correcting operation is applied in the embodiment of the present invention.

FIG. 8 is an explanatory schematic diagram for explaining an operation for calculating a correction coefficient to be used for an interpolating calculation operation embodied in the present invention.

FIG. 9a through FIG. 9d are explanatory schematic diagrams for explaining an image distortion correcting operation, namely: FIG. 9a is an explanatory schematic diagram being same as that shown in FIG. 7a; FIG. 9b is an explanatory schematic diagram being same as that shown in FIG. 7b; FIG. 9c shows a partially expanded schematic diagram of the schematic diagram shown in FIG. 9a; and FIG. 9d shows a partially expanded schematic diagram of the schematic diagram shown in FIG. 9b.

FIG. 10 is a block diagram indicating a rough configuration of an image processing apparatus embodied in the present invention.

FIG. 11 is a flowchart for explaining operational steps of Step S01 through Step S08 included in an image distortion correcting operation to be conducted by an image processing apparatus embodied in the present invention.

FIG. 12 is a block diagram indicating a rough configuration of an image forming apparatus embodied in the present invention.

FIG. 13 is a schematic diagram schematically indicating another arrangement structure that includes complimentary color family pixels and is to be employed for another imaging device of another embodiment of the present invention.

FIG. 14a through FIG. 14i are explanatory schematic diagrams indicating a process of an image distortion correcting operation, in a case that a pixel color arrangement structure is same as that shown in FIG. 13, namely: the schematic diagrams shown in FIG. 14a and FIG. 9a are the same as each other; FIG. 14b shows an enlarged schematic diagram of a part of the schematic diagram shown in FIG. 14a, indicating a rearrangement process of pixel data sets of colors G and Ye; FIG. 14c shows an enlarged schematic diagram of a part of the schematic diagram shown in FIG. 14a, indicating a rearrangement process of pixel data sets of color B; schematic diagrams shown in FIG. 14d and FIG. 9b are the same as each other, with respect to pixel data sets of color B; schematic diagrams shown in FIG. 14e and FIG. 9b are the same as each other, with respect to pixel data sets of color Ye; schematic diagrams shown in FIG. 14f and FIG. 9b are the same as each other, with respect to pixel data sets of color R; FIG. 14g shows an enlarged schematic diagram of a part of the schematic diagram shown in FIG. 14e; FIG. 14h shows an enlarged schematic diagram of a part of the schematic diagram shown in FIG. 14e; and FIG. 14i shows an enlarged schematic diagram of a part of the schematic diagram shown in FIG. 14f.

### BEST MODE FOR IMPLEMENTING THE INVENTION

Referring to the drawings, the best mode for implementing the invention will be detailed in the following.

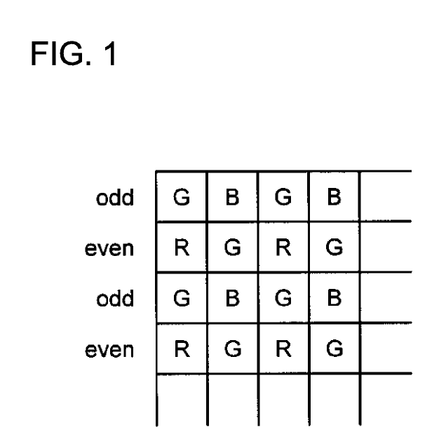

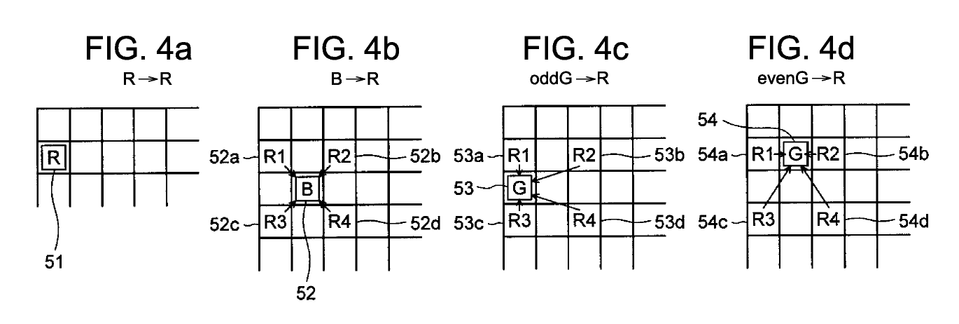

Initially, referring to FIG. 1, FIG. 4 through FIG. 8, the color separation interpolation processing, which is previously set forth in Tokkai 2009-157733 (Japanese Patent Application Laid-Open Publication) by one of the present inventors, will be detailed in the following.

FIG. 7a shows an explanatory schematic diagram for explaining an image before an image distortion correction operation is applied in the embodiment of the present invention, while FIG. 7b shows an explanatory schematic diagram for explaining another image after the image distortion correcting operation is applied in the embodiment of the present invention. The schematic diagram shown in FIG. 1, as aforementioned, schematically indicates the Bayer arrangement structure of general purpose in the raw image captured by the imaging device.

Hereinafter in the present specification, the term of “interpolation” is defined as an operation for calculating an outputting pixel by using at least one of peripheral pixels, while the term of “correction” is defined as an operation for moving a position of a pixel concerned, so as to perform the distortion correcting operation.

The operation for correcting the distortion included in the image, captured by using a wide-angle lens or a fish-eye lens, is achieved by replacing pixels with each other as shown in FIG. 7a and FIG. 7b. Concretely speaking, when a coordinate point of a pixel residing on a certain point within a circular image area, before the distortion correcting operation is applied, is represented by (X, Y), and another coordinate point of the same pixel residing on a corresponding point within a rectangular image area, after the distortion correcting operation has been applied, is represented by (X′, Y′), the pixel before correction is replaced with the corrected pixel by changing the coordinate point (X, Y) to the corrected coordinate point (X′, Y′). In this operation, since the inclination angle formed between the straight line extended from the center point (0, 0) to the concerned point before correction and the X-coordinate axis is the same as that formed between the straight line extended from the center point (0, 0) to the concerned point after correction and the X-coordinate axis, when the distance between the center point (0, 0) and the concerned point before correction is defined as “L”, while the other distance between the center point (0, 0) and the corresponding point after correction is defined as “L′”, the pixel before correction is replaced with the corrected pixel by changing the length “L” to the other length “L′”.

In this connection, although the coordinate values X′, Y′ included in the corrected coordinate point (X′, Y′) are integer values, the other coordinate values X, Y included in the coordinate point (X, Y) before correction, which is to be calculated from the corrected coordinate point (X′, Y′), are not necessary integer values, but is possibly represented by a real number including a decimal fraction in almost of all cases, as detailed later. Further in this connection, each of the coordinate pints is calculated on the basis of a correction LUT (Look Up Table) created from the characteristics of the lens to be employed. Still further, each of the pixels is rectangularly arranged in a two-dimensional domain, and when both of the coordinate values X, Y are integer, coincides with a position (center position) of any one of pixels, while, when any one of the coordinate values X, Y is represented by a real number including a decimal fraction, does not coincide with the position (center position) of the pixel.

In order to make it possible to achieve the distortion correcting operation, the relationship between the distance “L” before the distortion correcting operation is applied and the other distance “L′” after the distortion correcting operation has been applied, is found in advance based on the characteristics of the wide-angle lens and the fish-eye lens, and then, such the pixel replacing operation that the distance “L” is changed to the other distance “L′” with respect to the captured image, is conducted on the basis of the distortion correcting coefficient in regard to the relationship abovementioned.

Conventionally, the abovementioned pixel replacing operation to be conducted for correcting the distortion, caused by the wide-angle lens or the fish-eye lens, has been conducted at the time after the raw image data has been converted to the RGB image data Generally speaking, the image sensor (imaging device) outputs the raw image data in such the format that the pixels are arranged in the Bayer arrangement structure as shown in FIG. 1. However, since each position of the RGB primary colors is determined by making each of them correspond to each of the pixel positions arrayed in such the Bayer arrangement pattern, it is impossible to conduct an operation for randomly replacing the positions of pixels with each other. Accordingly, in the conventional image processing apparatus, it has been necessary to conduct the abovementioned pixel replacing operation after the raw image data has been converted to the RGB image data To overcome the abovementioned drawback, the present embodiment is so constituted that the pixel to be placed at the objective coordinate position is created from the peripheral pixels by conducting an interpolation calculating operation, so as to apply the distortion correcting operation directly to the raw image data without changing the raw image data to the RGB image data.

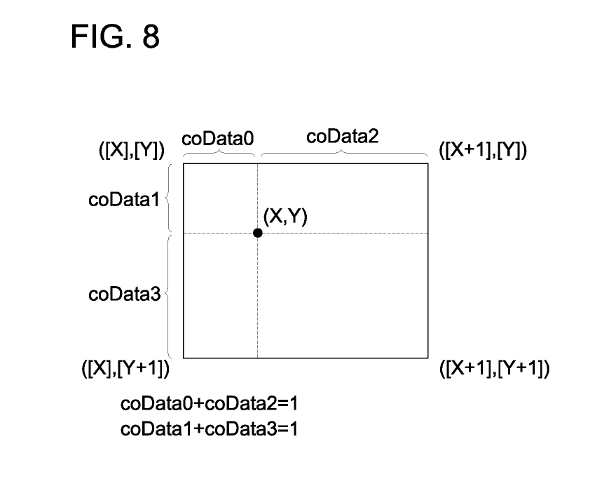

Next, referring to FIG. 4a through FIG. 6b and FIG. 8, a concrete example, in which the pixel data of the pixel to be placed at the objective coordinate position is derived from pixel data of the peripheral pixels arrayed in the Bayer arrangement pattern by performing the interpolating calculation, will be detailed in the following. FIG. 8 shows an explanatory schematic diagram for explaining an operation for calculating the correction coefficient to be used for the interpolating calculation operation embodied in the present invention.

### (1) When Color of Interpolated Pixel is “R” (Red)

As aforementioned, the color (RGB) of the distortion corrected pixel has been determined corresponding to the position of the distortion corrected pixel. The pixel data of the distortion corrected pixel is calculated on the basis of the pixel data of the peripheral pixels located around the position (X, Y) of the concerned pixel before the distortion correcting operation is applied, which corresponds to the other position (X′, Y′) of the corrected pixel.

In the present embodiment, the interpolation processing is achieved through tow processing including a first processing and a second processing. (i) In the first processing, pixel data sets of four pixels (corresponding to pixels 51-54 in FIG. 4), located near the position (X, Y) of the concerned pixel before the distortion correcting operation is applied, are acquired by performing the interpolation processing. Further, the interpolation processing is applied to each of the pixel data sets of the four pixels, from image data of a plurality of peripheral pixels having the color same as that of the corrected pixel. In this connection, the four positions of the abovementioned four pixels are corresponds to the pixel positions of the imaging device concerned, and are disposed at predetermined positions.

(ii) In the second processing, as shown in FIG. 8 detailed later, the pixel data of the pixel (imaginary pixel), located at the coordinate position (X, Y) before the distortion correcting operation is completed, is acquired from the four pixels acquired in the first processing and the relative position of the coordinate position (X, Y) by performing the interpolation processing. The abovementioned process will be concretely described in the following. Incidentally, hereinafter, the interpolation processing to be performed in the first processing and the second processing are also referred to as the first interpolation processing and the second interpolation processing, respectively.

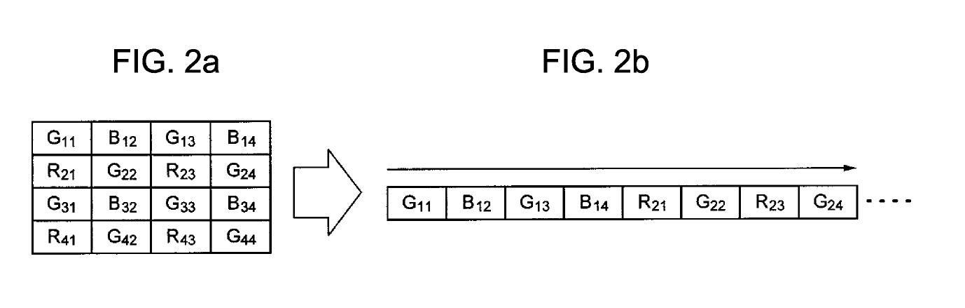

In this connection, although the two stage interpolation processing is exemplified as the embodiment of present invention, the one stage interpolation processing is also applicable in the present invention, as well. For instance, when the color of the pixel located at the coordinate position (X, Y) is “B” at a position near (within an area of) G22 shown in FIG. 2, the pixel data of the concerned pixel may be calculated from the pixel data sets of the four peripheral pixels having the same color (B12, B14, B32, B34) and the relative positional relationships between them.

### <First Interpolation Processing>

FIG. 4a, FIG. 4b, FIG. 4c and FIG. 4d show explanatory schematic diagrams, indicating peripheral pixels to be used for the interpolation calculation processing, when the color of the distortion corrected pixel is R (Red), and for explaining four cases including: case (a), in which the color of the pixel, before the interpolation processing is applied, is “R” (Red), and “R” is replaced with “R” (“R”→“R”); case (b), in which the color of the pixel, before the interpolation processing is applied, is “B” (Blue), and “B” is replaced with “R” (“B”→“R”); case (c), in which the color of the pixel, before the interpolation processing is applied, is “_{odd}G” (odd Green), and “_{odd}G” is replaced with “R” (“_{odd}G”→“R”); and case (d), in which the color of the pixel, before the interpolation processing is applied, is “ₑᵥₑₙG” (even Green), and is replaced with “R” (“ₑᵥₑₙG”→“R”), respectively, in the present embodiment.

In the first interpolation processing, pixel data sets of a plurality of pixels, disposed at predetermined peripheral positions located around the coordinate position (X, Y) before the distortion correcting operation is applied, are acquired by performing the interpolation processing. For instance, among intersections of the pixels concerned, an intersection being nearest to the coordinate position (X, Y) is calculated, and then, the pixel data sets of four pixels surrounding the intersection concerned are calculated. For instance, if the inter section being nearest to the coordinate position (X, Y) is surrounded by the pixel 51 through pixel 54, the pixel data sets of the pixel 51 through pixel 54 are calculated in regard to the color of the pixel after the distortion correcting operation is completed.

As shown in FIG. 4a, when the color of the pixel 51, before the interpolation processing is applied in the first interpolation processing, is “R” (Red), namely, when the colors of the pixel are the same as each other before and after the interpolation processing is applied (“R”→“R”), the pixel data of the pixel 51 is determined as pixel data R51 after the interpolation processing is completed, as it is.

As shown in FIG. 4b, when the color of the pixel 52, before the interpolation processing is applied, is “B” (Blue), namely, when the colors of the pixel are different from each other before and after the interpolation processing is applied (“B”→“R”), pixel data R52, defined as the interpolated pixel data, is found by applying the interpolation processing, in which pixel data R1, pixel data R2, pixel data R3 and pixel data R4 of pixel 52a, pixel 52b, pixel 52c and pixel 52d, respectively residing at four corners of the rectangular surrounding the pixel 52, are employed. An averaging processing for averaging the four pixel data could be cited as an example of the interpolation processing abovementioned.

As shown in FIG. 4b, when the color of the pixel 53, before the interpolation processing is applied, is “_{odd}G” having an odd number (“_{odd}G”→“R”), pixel data R53, defined as the interpolated pixel data, is found by applying the interpolation processing, in which pixel data R1, pixel data R2, pixel data R3 and pixel data R4 of the four pixels including pixel 53a and pixel 53c, located at the upper and lower sides of pixel 53, and pixel 53b and pixel 53d, located at the right side of pixel 53 and nearest to the pixel 53, are employed. Either an averaging processing for simply averaging the four pixel data or another averaging processing for averaging the four pixel data, each of which is weighted according to distance between pixels concerned, could be cited as an example of the interpolation processing abovementioned.

As shown in FIG. 4d, when the color of the pixel 54, before the interpolation processing is applied, is “ₑᵥₑₙG” having an even number (“ₑᵥₑₙG”→“R”), pixel data R54, defined as the interpolated pixel data, is found by applying the interpolation processing, in which pixel data R1, pixel data R2, pixel data R3 and pixel data R4 of the four pixels including pixel 54a and pixel 54b, located at the left and right sides of pixel 54, and pixel 54c and pixel 54d, located at the lower side of pixel 54 and nearest to the pixel 54, are employed.

### <Second Interpolation Processing>

Based on the pixel data (R51 through R54), acquired in the first interpolation processing, of the pixels (51 through 54), which are disposed on the predetermined positions located near the coordinate position (X, Y), the pixel data R, defined as interpolated pixel data of the coordinate position (X, Y), by employing Equation 1 to be employed in the second interpolation processing, shown as follow.

R=coData0·coData1·R51+·coData2·coData1·R54+coData0·coData3·R53+coData2·coData3·R52 <Equation 1>

Wherein, each of correction coefficients (coData0, coData1, coData2, coData3) can be calculated by using the relative positions with respect to the coordinate position (X, Y) in the coordinate system shown in FIG. 8, and it is defined as “coData0+coData1=1” and “coData2+coData3=1”. Further, in FIG. 8, the parenthesis of [ ] represents a Gaussian mark (or also referred to as a floor function), and [X] represents a maximum integer that does not exceed the value “X”. In this connection, in the schematic diagram shown in FIG. 8, ([X], [Y]), ([X+1], [Y+1]), ([X], [Y+1]) and ([X+1], [Y]) correspond to the positions of pixel 51 (pixel data R51), pixel 52 (pixel data R52), pixel 53 (pixel data R53), pixel 54 (pixel data R54), respectively.

### (2) When Color of Interpolated Pixel is “B” (Blue)

### <First Interpolation Processing>

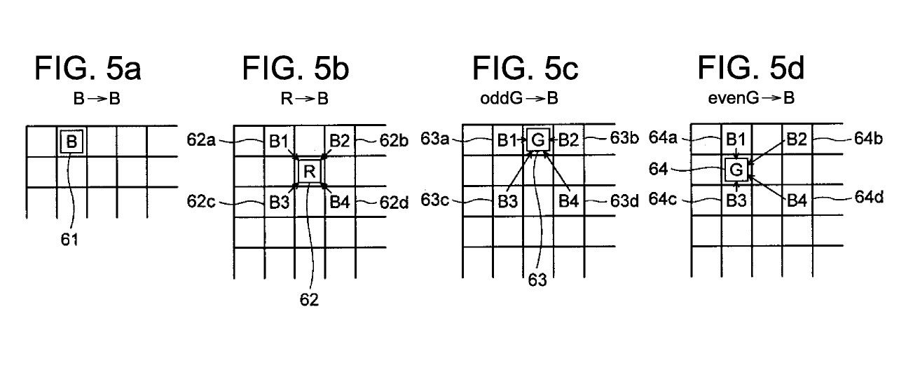

FIG. 5a, FIG. 5b, FIG. 5c and FIG. 5d show explanatory schematic diagrams, indicating peripheral pixels to be used for the interpolation calculation processing, when the color of the distortion corrected pixel is B (Blue), and for explaining four cases including: case (a), in which the color of the pixel, before the interpolation processing is applied, is “B” (Blue), and “B” is replaced with “B” (“B”→“B”); case (b), in which the color of the pixel, before the interpolation processing is applied, is “R” (Red), and “R” is replaced with “B” (“R”→“B”); case (c), in which the color of the pixel, before the interpolation processing is applied, is “_{odd}G” (odd Green), and “_{odd}G” is replaced with “B” (“_{odd}G”→“B”); and case (d), in which the color of the pixel, before the interpolation processing is applied, is “ₑᵥₑₙG” (even Green), and “ₑᵥₑₙG” is replaced with “B” (“ₑᵥₑₙG”→“B”), respectively, in the present embodiment.

As shown in FIG. 5a, when the color of the pixel 61, before the interpolation processing is applied, is “B” (“B”→“B”), the pixel data of the pixel 61 is determined as pixel data R61 after the interpolation processing is completed, as it is.

As shown in FIG. 5b, when the color of the pixel 62, before the interpolation processing is applied, is “R” (Red) (“R”→“B”), pixel data B, defined as the interpolated pixel data, is found by applying the interpolation processing, in which pixel data B1, pixel data B2, pixel data B3 and pixel data B4 of pixel 62a, pixel 62b, pixel 62c and pixel 62d, respectively residing at four corners of the rectangular surrounding the pixel 62, are employed, and by applying the averaging processing or the like, as aforementioned.

### <Second Interpolation Processing>

As well as in the case of “R”, the pixel data B, defined as interpolated pixel data of the coordinate position (X, Y), can be found by employing an Equation substantially same as Equation 1 employed in the second interpolation processing of the case of “R”. The detailed explanations on this matter are omitted.

### (3) When Color of Interpolated Pixel is “G” (Green)

### <First Interpolation Processing>

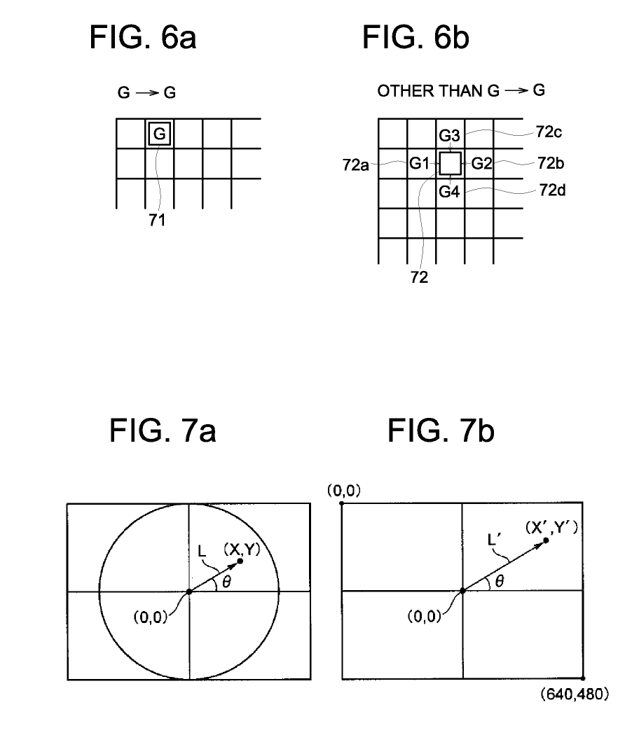

FIG. 6a and FIG. 6b show explanatory schematic diagrams, indicating peripheral pixels to be used for the interpolation calculation processing, when the color of the distortion corrected pixel is G (Green), and for explaining two cases including: case (a), in which the color of the pixel, before the interpolation processing is applied, is “G” (Green), and “G” is replaced with “G” (“G”→“G”); and case (b), in which the color of the pixel, before the interpolation processing is applied, is “R” (Red) or “B” (Blue), other than “G” (Green), and “R” or “B” is replaced with “G” (other than “G”→“G”).

As shown in FIG. 6a, when the color of the pixel 71, before the interpolation processing is applied, is “G” (“G”→“G”), the pixel data of the pixel 71 is determined as pixel data R71 after the interpolation processing is completed, as it is.

As shown in FIG. 6b, when the color of the pixel 72, before the interpolation processing is applied, is “R” (Red) or “B” (Blue), other than “G” (Green) (other than “G”→“G”), pixel data G, defined as the interpolated pixel data, is found by applying the interpolation processing, in which pixel data G1, pixel data G2, pixel data G3 and pixel data G4 of pixel 72a, pixel 72b, pixel 72c and pixel 72d, respectively located at the four sides of the rectangular surrounding the pixel 72, are employed, and by applying the averaging processing or the like, as aforementioned.

As described in the foregoing, when the distortion correcting operation is conducted by performing the pixel replacing operation while changing the distance “L” before the distortion correcting operation is applied as shown in FIG. 7a to the distance “L” after the distortion correcting operation is completed as shown in FIG. 7b, it becomes possible to accurately find the interpolated pixel data of the pixel after the pixel replacing operation is completed, by performing the interpolation calculating operation for calculating the interpolated pixel data from the four pixels residing at peripheral positions in the vicinity of the pixel before the pixel replacing operation is applied (four pixels having the color same as that of the pixel after the pixel replacing operation is completed). Accordingly, it becomes possible to apply the distortion correcting operation directly to the raw image data without deteriorating the image quality considerably, before the raw image data is converted to the RGB image data.

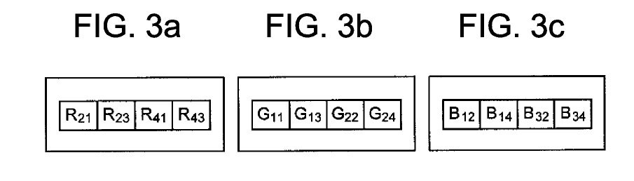

As aforementioned, in the conventional technology cited as the comparison example, in the case of performing the interpolation calculating operation for calculating the interpolated pixel data from the four pixels residing at peripheral positions in the vicinity of the pixel before the pixel replacing operation is applied (four pixels having the color same as that of the pixel after the pixel replacing operation is completed), since pixel data sets corresponding to R1-R4, B1-B4 and G1-G4 are stored in the positions being separate from each other as shown in FIG. 2b, there has been such a drawback that the standby waiting time, caused by the access time, increases when they are read from the storage device (memory). In order to shorten the standby waiting time abovementioned, the pixel data sets are grouped into the three groups respectively corresponding to R (Red), G (Green) and B (Blue), so as to store the three groups into the corresponding storage areas of the storage device, respectively, as shown in FIG. 3a through FIG. 3c. As a result, it becomes possible to read the necessary pixel data sets at a time, and accordingly, it becomes possible shorten the access time.

In this connection, when the interpolation processing is conducted by employing the pixel data of the four pixels (R1-R4, B1-B4 and G1-G4) residing at the peripheral positions in the vicinity of the concerned pixel and extracted from the image data area of 3×3, as shown in FIG. 4a through FIG. 6b, it is preferable that the capacity of the storage area in a unit of block is greater than that of storing pixel data of four pixels.

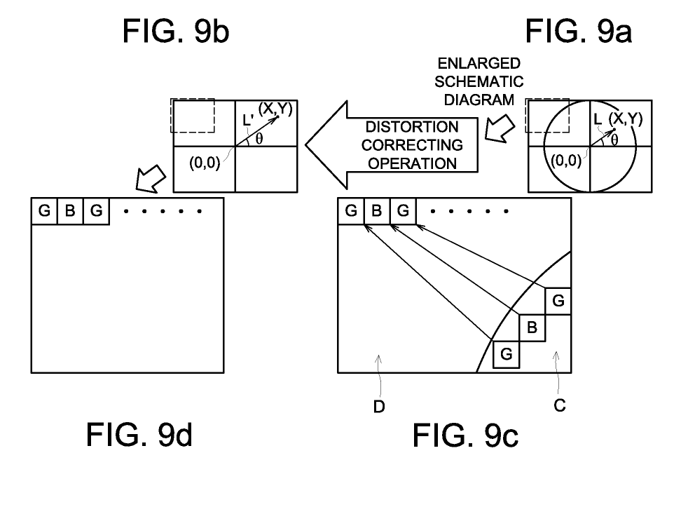

Referring to FIG. 9a through FIG. 9d, the distortion correcting operation, shown in FIG. 7a and FIG. 7b, and the pixel data storing operation will be further detailed in the following.

FIG. 9a through FIG. 9d show explanatory schematic diagrams for explaining the image distortion correcting operation. FIG. 9a shows an explanatory schematic diagram being same as that shown in FIG. 7a, FIG. 9b shows an explanatory schematic diagram being same as that shown in FIG. 7b, FIG. 9c shows a partially expanded schematic diagram of the schematic diagram shown in FIG. 9a and FIG. 9d shows a partially expanded schematic diagram of the schematic diagram shown in FIG. 9b.

When the imaging device captures an image projected thereon through a lens optical system, for instance, the captured image tends to circularly shrink towards the center of the image concerned, due to the influence of the distortion inherent to the lens optical system as shown in FIG. 9a. Specifically, when the lens optical system includes the wide-angle lens or the fish-eye lens, the abovementioned trend becomes considerable. When the image data representing the distorted image shown in FIG. 9a is converted to the corrected image data representing the corrected image shown in FIG. 9b through an image processing process, pixel data sets residing within an effective image data area C, which has shrunken as shown in FIG. 9c, are rearranged into an area including an ineffective image data area D as shown in FIG. 9c and FIG. 9d, so as to make the corrected image represent such an image that is equivalent to a normally visualized image. As abovementioned, in this image processing process, based on the parameters inherent to the lens optical system concerned, the particular rearrangement processing is applied to the pixel data sets included in the distorted image. In the conventional image processing process as set forth in Patent Document 1, when the distortion of the image including the pixels arranged in the Bayer arrangement structure is corrected, the data structure of the pixel data sets to be stored in the storage device has been such that the pixel data sets having plural colors are arranged as the continuous serial data still in the form of the Bayer arrangement structure.

On the other hand, according to the present embodiment, as shown in FIG. 3a through FIG. 3c, the pixel data sets, included in the image data concerned, are grouped into the three groups respectively corresponding to primary colors of R (Red), G (Green) and B (Blue), so as to rearrange and store pixel data sets, included in each of the three groups, into the corresponding one block of the storage areas. Then, the interpolation processing is conducted by employing the pixel data sets included in each of the three groups corresponding to the three primary colors. Since the interpolation processing can be conducted by reading the pixel data sets of the four pixels located at the positions surrounding the concerned pixel before the distortion correcting operation is applied, it becomes possible to speedily conduct the data accessing operation.

The bus width (bit), to be employed at the time when the image distortion correction processing abovementioned is performed, is the same as the size of the one block storage area, and the size of the storage area is set at such a capacity that is sufficiently greater than a unit of plural pixels to be employed for the interpolation processing (four pixels in the present embodiment). Accordingly, since the image data sets corresponding to at least four pixels can be read from the one block storage area, as indicated in each of the schematic diagrams respectively shown in FIG. 3a through FIG. 3c, within one cycle of the accessing operation, the access time for accessing the storage device can be shortened, and as a result, it becomes possible to perform a high speed processing.

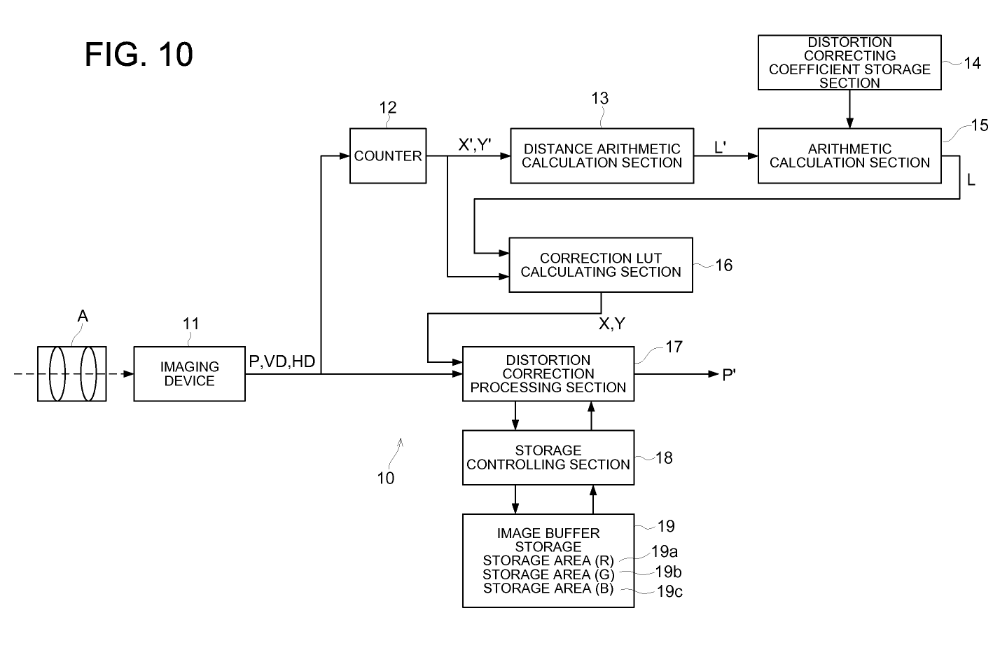

Next, referring to the block diagram shown in FIG. 10, the image processing apparatus embodied in the present invention will be detailed in the following. FIG. 10 shows a block diagram indicating an image processing apparatus embodied in the present invention.

As shown in FIG. 10, an image processing apparatus 10 is provided with: an imaging device 11 into which light emitted from a subject image to be captured enters through a wide angle lens A; a counter 12; a distance arithmetic calculation section 13; a distortion correcting coefficient storage section 14; an arithmetic calculation section 15; a correction LUT (Look Up Table) calculating section 16; a distortion correction processing section 17; an image buffer storage 19 and a storage controlling section 18. In this connection, the wide angle lens A is constituted by a lens optical system including a plurality of lenses, so as to make it possible to acquire a wide angle image.

The imaging device 11 is constituted by an image sensor, such as CCD (Charge Coupled Device), CMOS (Complementary Metal-Oxide Semiconductor), etc., each of which includes a plenty of pixels, and outputs raw image data representing the captured image according to the Bayer arrangement structure shown in FIG. 1. The counter 12 detects a vertical synthesizing signal VD or a horizontal synthesizing signal HD outputted from the imaging device 11 so as to output a distortion corrected coordinate position (X′, Y′). The distance arithmetic calculation section 13 calculates a distance L′ between the distortion corrected coordinate position (X′, Y′) and the center position from the distortion corrected coordinate position (X′, Y′) as shown in FIG. 9b.

The distortion correcting coefficient storage section 14 includes various kinds of storage devices, such as a ROM (Read Only Memory), a RAM (Random Access Memory), etc., so as to store the image distortion correcting coefficients corresponding to the lens characteristics of the wide angle lens A. On the other hand, based on the distance L′ from the center position after the distortion correcting operation has been completed and the distortion correcting coefficient stored in the distortion correcting coefficient storage section 14, the arithmetic calculation section 15 calculates a distance L from the center position before the distortion correcting operation is applied, and further calculates the coordinate position (X, Y) before the distortion correcting operation is applied, from the distance L and the distortion corrected coordinate position (X′, Y′).

The correction LUT calculating section 16 calculates a correction LUT (Look Up Table) in which the distance L, the distance L′, the original coordinate position (X, Y) and the distortion corrected coordinate position (X′, Y′) are correlated with each other, acquired as abovementioned.

The distortion correction processing section 17 replaces each of the pixels, represented by the raw image data P inputted, with the corresponding one of the corrected pixels while referring to the correction LUT calculated by the correction LUT calculating section 16, so as to achieve the distortion correction processing. In this distortion correction processing, the distortion correction processing section 17 derives each of the corrected pixel data sets after the distortion correcting operation, from the corresponding one of raw pixel data sets, which are stored in the image buffer storage 19, detailed later, for every one of the primary colors, by performing the interpolation processing aforementioned by referring to FIG. 4a through FIG. 6b and FIG. 8. Through the abovementioned process, the distortion correction processing section 17 outputs the distortion-corrected raw image data P′.

The image buffer storage 19 is provided with storage areas 19a, 19b and 19c, which correspond to the RGB primary colors, respectively, and each of which serves as readable storage area for storing the pixel data in a unit of four pixels for corresponding one of the RGB primary colors, when the interpolation processing is conducted, with respect to the color of the predetermined pixel after the interpolation processing has been completed, by employing the pixel data of the four pixels residing at the peripheral positions in the vicinity of the concerned pixel and extracted from the image data area of 3×3, as shown in FIG. 4a through FIG. 6b.

The image buffer storage 19 temporarily stores the raw image data, representing the image captured by the imaging device 11, into the storage areas 19a, 19b and 19c in a unit of one block through a cache memory. On this occasion, the pixel data sets are grouped into the three groups respectively corresponding to R (Red), G (Green) and B (Blue), so as to store the three groups into the storage areas 19a, 19b and 19c, respectively, as indicated in the schematic diagrams shown in FIG. 3a through FIG. 3c.

The storage controlling section 18 controls the operations for outputting and inputting the raw image data to be communicated between the image buffer storage 19 and the distortion correction processing section 17.

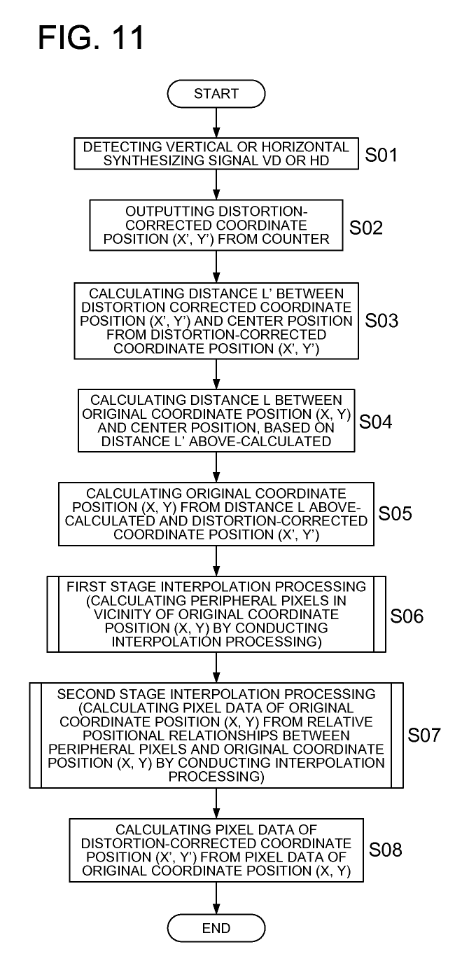

Next, referring to the flowchart shown in FIG. 11, the operational steps of Step S01 through Step S08 included in the image distortion correcting operation to be conducted by the image processing apparatus 10, indicated in the block diagram shown in FIG. 10, will be detailed in the following.

Initially, detecting either the vertical synthesizing signal VD or the horizontal synthesizing signal HID included in the electric signals sent from the imaging device 11 (Step S01), the counter 12 outputs the distortion corrected coordinate position (X′, Y′) (Step S02). The abovementioned operation for outputting the distortion corrected coordinate position (X′, Y′) is commenced from, for instance, the start point (0, 0) located at a left upper corner of the rectangular area of the distortion corrected image shown in FIG. 7b.

Successively, the distance arithmetic calculation section 13 calculates a distance L′ between the distortion corrected coordinate position (X′, Y′) and the center position from the distortion corrected coordinate position (X′, Y′) (Step S03).

Still successively, based on the image distortion correcting coefficient read from the distortion correcting coefficient storage section 14, the arithmetic calculation section 15 calculates a distance L between the original coordinate position (X, Y) before the distortion correcting operation is applied and the center position, from the distance L′ above-calculated (Step S04).

Still successively, the correction LUT calculating section 16 calculates the original coordinate position (X, Y) before the distortion correcting operation is applied, from the distance L above-calculated and the distortion corrected coordinate position (X′, Y′) after the distortion correcting operation is applied (Step S05).

Since the raw image data P, transmitted from the imaging device 11, has been stored into the storage areas 19a, 19b and 19c of the image buffer storage 19 in such a manner that the three groups of pixel data sets corresponding to R, G and B are respectively stored into the storage areas 19a, 19b and 19c as shown in FIG. 3a through FIG. 3b, the raw image data stored into any one of the storage areas 19a, 19b and 19c is read out therefrom, as needed, under the operating actions conducted by the storage controlling section 18. The distortion correction processing section 17 selects peripheral pixels in the vicinity of the original coordinate position (X, Y) calculated in Step S05, by applying the first stage interpolation processing (first interpolation processing: refer to the schematic diagrams shown in FIG. 4a through FIG. 6b) to the raw image data above-read, so as to calculate the pixel data (R51 through R54 in the example shown in FIG. 4) of the color of the distortion corrected coordinate position (X′, Y′) of the peripheral pixels above-selected (Step S06).

Still successively, based on the relative positional relationships between the peripheral pixels selected in Step S06 and the original coordinate position (X, Y), and the pixel data of the peripheral pixels, the distortion correction processing section 17 calculates the pixel data of the original coordinate position (X, Y) by conducting the second stage interpolation processing (second interpolation processing: refer to the schematic diagram shown in FIG. 8) (Step S07).

Yet successively, the pixel data of the coordinate position (X, Y) calculated in Step S07 is used as the pixel data of the distortion corrected coordinate position (X′, Y′) (Step S08).

By repeatedly conducting the operational steps of Step S01 through Step S08 abovementioned, with respect to all of the pixels included in the rectangular area of the distortion corrected image shown in FIG. 7b, from the start point (0, 0), located at the left upper corner of the rectangular area, to the final point (640, 480), located at the right lower corner of the rectangular area, while sequentially shifting the concerned pixel one pixel by one pixel, the image distortion correcting operations with respect to all of the pixels included in the distortion corrected image, shown in FIG. 7b, can be achieved.

As described in the foregoing, according to the image processing method and apparatus, both embodied in the present invention, since the pixel data of the pixel to be placed at the objective coordinate position is found from the pixel data of the peripheral pixels by conducting an interpolation calculating operation, it is possible to apply the distortion correcting operation directly to the raw image data without changing the raw image data to the RGB image data and without causing deterioration of the image quality. Accordingly, it becomes possible not only to perform a high speed processing, but also to reduce the storage capacity, which is necessary for the pixel replacing operation.

Further, according to present embodiment, since the interpolation calculating operation is conducted by reading out each of the pixel data sets, respectively corresponding to primary colors R, G and B, from the storage areas 19a, 19b and 19c into which the three groups of the pixel data sets corresponding to R, G and B are respectively stored, it becomes possible to eliminate the standby waiting time, to shorten the access time and to perform the high speed processing, instead of such the operation for reading data in the storing state as shown in FIG. 2b. As described in the foregoing, when the image distortion correcting operation is performed, by rearranging the storing order of the pixel data sets to be stored, so as to comply with the high speed processing use, it becomes possible to achieve the improvement of the accessing velocity, and as a result, it also becomes possible to improve the image processing velocity faster than ever. In addition, since it is not necessary to specifically increase the storage capacity, it becomes possible to reduce the power consumption and the heat generation of the concerned apparatus.

Still further, as well as the other interpolating calculation (bilinear, bi-cubic), there can be obtained such the effect that the gradation of the concerned image is made to be smooth. Yet further, since row image data is inputted and outputted into/from the image processing apparatus 10, it becomes possible to apply an ISP (Image Signal Processing) to the raw image data after the image distortion correcting operation has been completed, namely, various kinds of image processing according to the ISP can be applied to the distortion corrected raw image data to which the image distortion correcting operation has been already applied.

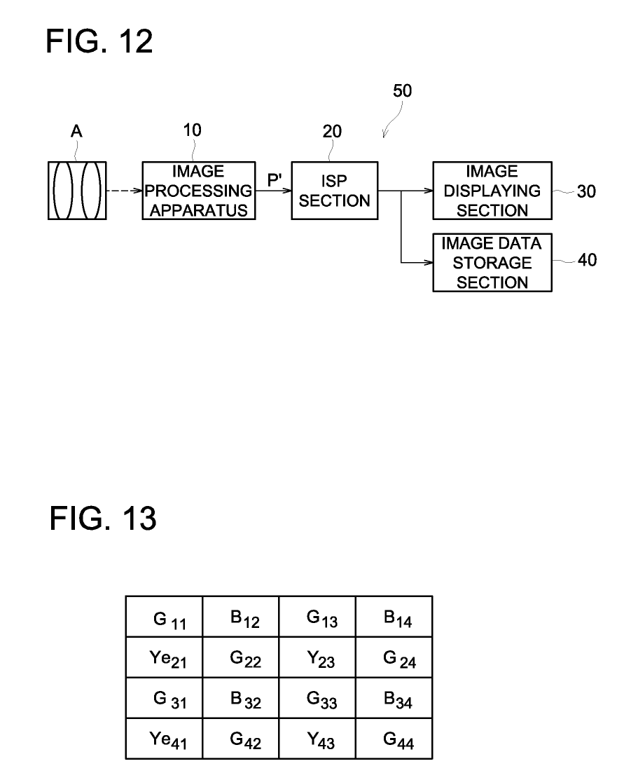

Next, referring to the block diagram shown in FIG. 12, an image forming apparatus, including the image processing apparatus 10 shown in FIG. 10, will be detailed in the following. FIG. 12 shows a block diagram indicating a rough configuration of the image forming apparatus embodied in the present invention.

As shown in FIG. 12, an image forming apparatus 50 is provided with the wide angle lens A, the image processing apparatus 10 shown in FIG. 10, an ISP (Image Signal Processing) section 20, an image displaying section 30 and an image data storage section 40, so as to make it possible to configure a digital still camera.

When light emitted from an image, serving as a subject to be captured, is projected onto the imaging device 11 shown in FIG. 10 through the wide angle lens A, the image forming apparatus 50 conducts the consecutive operations of applying the distortion correction processing to the raw image data P outputted by the imaging device 11 in such the manners as indicated by the schematic diagrams shown in FIG. 4a through FIG. 8; inputting the distortion-corrected raw image data P′ after the distortion correction processing has been completed, into the ISP section 20; applying various kinds of image processing, such as a white balance processing, a color correction processing, a gamma correction processing, etc., to the distortion-corrected raw image data P′ after the distortion correction processing has been completed, in the ISP section 20; and displaying a reproduced image, represented by the processed image data acquired by applying the abovementioned image processing, onto the image displaying section 30 including an LCD (Liquid Crystal Display) or the like, and then, storing the processed image data into the image data storage section 40.

As described in the above, according to the image forming apparatus 50 shown in FIG. 12, since the distortion-corrected raw image data, acquired by applying the distortion correction processing to the raw image data of the image captured through the wide angle lens A, is outputted to the ISP section 20 so as to apply the various kinds of image processing (Image Signal Processing) to the distortion-corrected raw image data therein, it becomes possible not only to complete the distortion correction processing before applying the ISP, but also to speedily find the pixel data by conducting the interpolation calculating operation when the colors of concerned pixel are different from each other before and after the distortion correction processing is applied. Accordingly, since the various kinds of image processing (Image Signal Processing) are applied to the distortion-corrected raw image data after the distortion correction processing has been completed, it becomes possible to acquire such a reproduced image that is more natural than ever, in a relatively high-speed manner.

In the foregoing, the best mode for implementing the present invention has been described. However, the scope of the present invention is not limited to the embodiments disclosed in the foregoing, modifications and additions made by a skilled person without departing from the spirit and scope of the invention shall be included in the scope of the present invention. For instance, although the wide angle lens A has been exemplified as such a lens that is to be disposed in front of the imaging device 11 in the schematic diagrams shown in FIG. 10 and FIG. 12, the scope of the lens applicable in the present invention is not limited to the wide angle lens. The fish eye lens, which is capable of capturing a wide eyesight image, is also applicable in the present invention, and further, another kind of lens, which requires the distortion correcting operation, is also applicable in the present invention.

### Other Embodiments

Next, another embodiment, in which the color filter of the imaging device includes color filter pixels corresponding to colors other than R, G and B, such as complimentary colors, etc., which are to be used for calculating R, G and B (hereinafter, referred to as a complimentary color family, for simplicity, and the above-defined color filter pixel is referred to as a complimentary color family pixel or a complimentary color pixel), will be detailed in the following. In the other embodiment, finally, it is necessary to find the pixel data sets of R, G and B from the pixel data of the complimentary color family pixels by conducting arithmetic calculations.

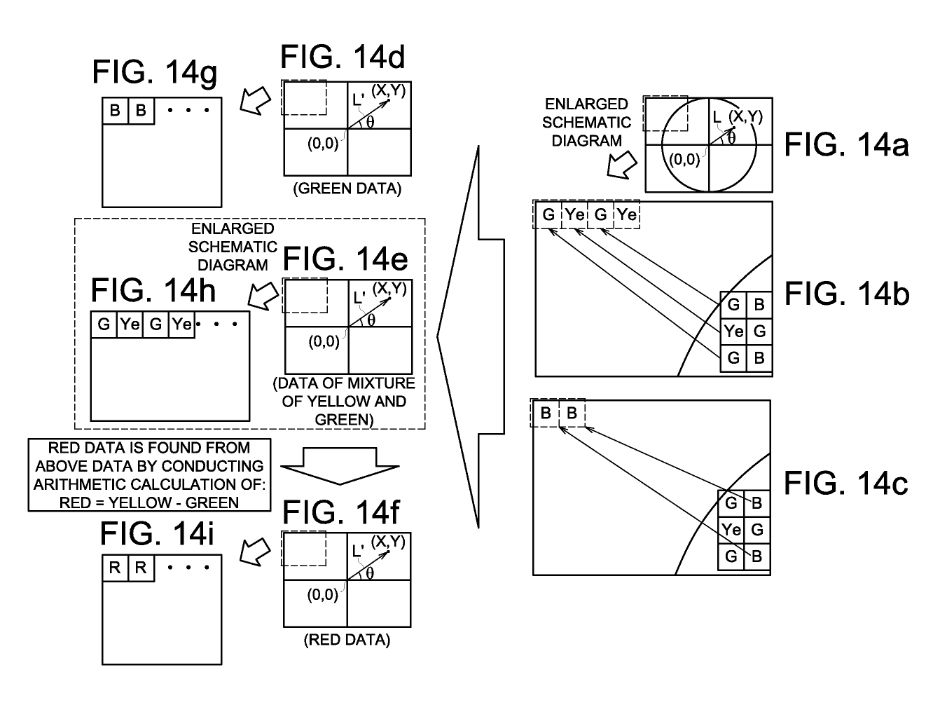

The examples of the combinations of colors to be used for calculating R, G and B are indicated as follows (items 1 through 9). Referring to FIG. 13 and FIG. 14, examples of employing colors Yellow and Green, and employing a color Blue will be detailed in the following, as representative examples when the complimentary color family pixels are included.
1. Yellow and Green→Red
2. Yellow and Red→Green
3. Cyan and Green→Blue
4. Cyan and Blue→Green
5. White and Yellow→Blue
6. White and Cyan→Red
7. White and Magenta→Green
8. Magenta and Red→Blue
9. Magenta and Blue→Red

FIG. 13 shows a schematic diagram indicating an exemplary color arrangement structure including the complimentary color pixels to be arranged in the imaging device. In the aforementioned embodiment described by referring to FIG. 3a through FIG. 12, the raw image data sets of the pixels have been arranged and stored into the storage areas of one block in such a manner that the three groups of the pixel data sets corresponding to R, G and B are respectively stored into the storage areas as shown in FIG. 3a through FIG. 3c, so as to implement the interpolation processing by using the stored pixel data sets corresponding to R, G and B, and then, the image distortion correcting operation is conducted on the basis of the interpolated pixel data. In the other embodiment indicated by the schematic diagrams shown in FIG. 13, etc., the aforementioned process indicated by the schematic diagrams shown in FIG. 3a through FIG. 12 is also implemented as well. Namely, the raw image data sets of the pixels have been arranged and stored into the storage areas of one block in such a manner that the three groups of the pixel data sets corresponding to Y (Yellow), G (Green) and B (Blue) are respectively stored into the storage areas as shown in FIG. 3a through FIG. 3c, so as to implement the interpolation processing by using the stored pixel data sets corresponding to Y, G and B, and then, the image distortion correcting operation is conducted on the basis of the interpolated pixel data.

FIG. 14a through FIG. 14i show explanatory schematic diagrams indicating the process of the image distortion correcting operation in the case of the pixel color arrangement structure shown in FIG. 13. Further, the schematic diagrams shown in FIG. 14a and FIG. 9a are the same as each other; FIG. 14b shows the enlarged schematic diagram of a part of the schematic diagram shown in FIG. 14a, indicating a rearrangement process of the pixel data sets of colors G and Ye; FIG. 14c shows the enlarged schematic diagram of a part of the schematic diagram shown in FIG. 14a, indicating a rearrangement process of the pixel data sets of color B; the schematic diagrams shown in FIG. 14d and FIG. 9b are the same as each other, with respect to the pixel data sets of color B; the schematic diagrams shown in FIG. 14e and FIG. 9b are the same as each other, with respect to the pixel data sets of color Ye; the schematic diagrams shown in FIG. 14f and FIG. 9b are the same as each other, with respect to the pixel data sets of color R; FIG. 14g shows the enlarged schematic diagram of a part of the schematic diagram shown in FIG. 14e; FIG. 14h shows the enlarged schematic diagram of a part of the schematic diagram shown in FIG. 14e; and FIG. 14i shows the enlarged schematic diagram of a part of the schematic diagram shown in FIG. 14f.

The difference between the other embodiment and the aforementioned embodiment will be detailed in the following. In the other embodiment shown in FIG. 14, the distortion corrected pixel data is stored into the storage in such a manner that the pairs of pixel data sets to be employed for calculating R, G and B are continuously stored, while the pixel data sets of the color, other than the above, are continuously stored for every color. Concretely speaking, with respect to colors Ye and G, which are to be employed for calculating R, the pixel data sets of Ye and G are continuously stored in the storage, while, with respect to color B, other than colors Ye and G, only the pixel data sets of color B are continuously stored into the storage. The reasons for the abovementioned will be detailed in the following.

In the case of the pixel color arrangement structure including complimentary color pixels, when the pixel data sets corresponding to R, G and B are found from the complimentary color pixel data by performing the arithmetic calculation, for instance in the pixel color arrangement structure shown in FIG. 13, the pixel data of color R (Red) is usually found by subtracting the pixel data of color G (Green) from the pixel data of color Ye (Yellow), according to Equation (1) indicated as follow.

R(Red)=Ye(Yellow)−G(Green) (1)

Instead of independently processing the pixel data of color Ye serving as a color included in the complimentary color family other than the primary colors (R, G and B), the pixel data of color R, found according to Equation (1) abovementioned, is usually utilized for the processing concerned. Accordingly, it is desirable that the image distortion corrected pixel data of color Ye is stored into such the storage area that is same as that of the pixel data of color G, and pixel data of a vicinity coordinate point is continued to the pixel data of color G.

FIG. 14a through FIG. 14i show the explanatory schematic diagrams for explaining the process of the image distortion correcting operation to be conducted in the other embodiment. Concretely speaking, as shown in FIG. 14b and FIG. 14h, the distortion correction processing is applied to pixel data sets including those of color Ye categorized in the complimentary color family, and on that occasion, pixel data sets of colors Ye and G are stored into the storage areas of the same block, and at the same time, the pixel data set of color R is found by employing Equation (1) abovementioned, so as to perform the distortion correction processing for the pixel data set of color R as shown in FIG. 14f and FIG. 14i, and then, the pixel data set concerned is stored into the storage area of one block. Accordingly, when conducting the operation for converting to image data in which BGR pixel data is allotted to one pixel as a post processing of the abovementioned process, it becomes possible to read the pixel data of the pixel to be employed for calculating the RGB from the storage area of one block within a one cycle operation period. Therefore, it becomes possible to shorten the accessing time for accessing the storage device concerned, and as a result, the high speed processing becomes possible.

### EXPLANATION OF THE NOTATIONS

10 an image processing apparatus
11 an imaging device
17 a distortion correction processing section
18 a storage controlling section
19 an image buffer storage
19a-19c storage areas
50 an image forming apparatus
A a wide angle lens

1-11. (canceled)

12. An image distortion correcting method, for correcting distortion included in a captured image, which is to be conducted in an image processing apparatus which includes an optical system and an imaging device provided with a plurality of pixels, each of which corresponds to one of colors, so as to capture an image projected thereon through the optical system, the image distortion correcting method comprising:
when a color of an original pixel, which is one of the plurality of pixels before the image distortion correcting operation is applied, is different from that of a distortion-corrected pixel, which is to be acquired after the image distortion correcting operation has been applied to the original pixel, conducting an interpolation processing to calculate a pixel data of the distortion-corrected pixel from other pixel data of plural pixels residing at peripheral positions surrounding the original pixel, which has been stored in a storage section; and
storing pixel data categorized in one of the colors as a continuous series of the pixel data into a corresponding one of storing areas provided in the storage section.

13. The image distortion correcting method of claim 12, wherein a storing capacity of each of the storing areas in a unit of one block is set at a size that is greater than a unit of the plural pixels to he employed in the interpolation processing.

14. The image distortion correcting method of claim 12, wherein, when the colors include colors to be employed for calculating Red (R), Green (G), and Blue (B), an operation for storing pixel data of the distortion-corrected pixels into the storage section is conducted in such a manner that pixel data of combinations of the colors to be employed for calculating R, G, and B is continuously conducted.

15. An image distortion correction method, for correcting distortion included in a captured image, which is to be conducted in an image processing apparatus which includes an optical system and an imaging device provided with a plurality of pixels, each of which corresponds to one of colors, so as to capture an image projected thereon through the optical system, the image distortion correcting method comprising:
when a color of an original pixel, which is one of the plurality of pixels before the image distortion correcting operation is applied, the same as that of a distortion-corrected pixel, which is to be acquired after the image distortion correcting operation has been applied to the original pixel, conducting an interpolation processing to calculate a pixel data of the distortion-corrected pixel from other pixel data of plural pixels residing at peripheral positions surrounding the original pixel, which has been stored in a storage section; and
storing pixel data categorized in one of the colors as a continuous series of the pixel data into a corresponding one of storing areas provided in the storage section.

16. The image distortion correcting method of claim 15,
wherein the interpolation processing includes:
a first processing in which, when a color of a specific pixel arranged at a predetermined position within a peripheral space surrounding the original pixel is the same as that of the distortion-corrected pixel, other pixel data of the specific pixel arranged at the predetermined position is used as is, while, when the color of the specific pixel arranged at the predetermined position is different from that of the distortion-corrected pixel, the specific pixel arranged at the predetermined position is acquired by interpolating with pixel data of plural pixels residing around a peripheral space thereof, a color of the plural pixels being the same as that of the distortion-corrected pixel; and
a second processing in which pixel data of the distortion-corrected pixel is acquired by conducting the interpolating operation based on a relative positional relationship between a position of the original pixel and the specific pixel arranged at the predetermined position, and the pixel data of the plural pixels arranged at the predetermined positions and acquired in the first processing.

17. The image distortion correction method of claim 15, wherein a storing capacity of each of the storing areas in a unit of one block is set at a size that is greater than a unit of the plural pixels to be employed in the interpolation processing.

18. The image distortion correction method of claim 15, wherein, when the colors include colors to be employed for calculating Red (R), Green (G), and Blue (B), an operation for storing pixel data of the distortion-corrected pixels into the storage section is conducted in such a manner that pixel data of combinations of the colors to be employed for calculating R, G, and B is continuously conducted.

19. An image processing apparatus that conducts an image distortion correcting operation for correcting distortion included in a captured image, comprising:
an optical system;
an imaging device that is provided with a plurality of pixels, each of which corresponds to one of colors, so as to capture an image projected thereon through the optical system;
an arithmetic calculating section to process image data representing the image and outputted by the imaging device; and
a storage section to store the image data therein;
wherein, when a color of an original pixel, which is one of the plurality of pixels before the image distortion correcting operation is applied, is different from that of a distortion-corrected pixel, which is to be acquired after the image distortion correcting operation has been applied to the original pixel, the arithmetic calculating section conducts an interpolation processing to calculate pixel data of the distortion-corrected pixel from other pixel data of plural pixels residing at peripheral positions surrounding the original pixel, which has been stored in the storage section, and the arithmetic calculating section stores pixel data categorized in one of the colors as a continuous series of the pixel data into a corresponding one of storing areas provided in the storage section.

20. The image processing apparatus of claim 19, wherein a storing capacity of each of the storing areas in a unit of one block is set at a size that is greater than a unit of plural pixels to be employed in the interpolation processing.

21. The image processing apparatus of claim 19, wherein, when the colors include colors to be employed for calculating Red. (R), Green (G), and Blue (B), an operation for storing pixel data of the distortion-corrected pixels into the storage section is conducted in such a manner that pixel data of combinations of the colors to be employed for calculating R, G, and B is continuously conducted.

22. The image processing apparatus of claim 19, wherein the optical system comprises an optical system that is used for capturing a wide angle image.

23. An image processing apparatus that conducts an image distortion correcting operation for correcting distortion included in a captured image, comprising:
an optical system;
an imaging device that is provided with a plurality of pixels, each of which corresponds to one of colors, so as to capture an image projected thereon through the optical system;
an arithmetic calculating section to process image data representing the image and outputted by the imaging device; and
a storage section to store the image data therein;
wherein, when a color of an original pixel, which is one of the plurality of pixels before the image distortion correcting operation is applied, is the same as that of a distortion-corrected pixel, which is to be acquired after the image distortion correcting operation has been applied to the original pixel, the arithmetic calculating section conducts an interpolation processing to calculate pixel data of the distortion-corrected pixel from other pixel data of plural pixels residing at peripheral positions surrounding the original pixel, which has been stored in the storage section, and the arithmetic calculating section stores pixel data categorized in one of the colors as a continuous series of the pixel data into a corresponding one of storing areas provided in the storage section.

24. The image processing apparatus of claim 23
wherein the arithmetic calculating section conducts the interpolation processing including:
a first processing in which, when a color of a specific pixel arranged at a predetermined position within a peripheral space surrounding the original pixel is the same as that of the distortion-corrected pixel, other pixel data of the specific pixel arranged at the predetermined position is used as is, while, when the color of the specific pixel arranged at the predetermined position is different from that of the distortion-corrected pixel, the specific pixel arranged at the predetermined positions is acquired by interpolating with pixel data of plural pixels residing around a peripheral space thereof, a color of the plural pixels being the same as that of the distortion-corrected pixel; and
a second processing in which pixel data of the distortion-corrected pixel is acquired by conducting the interpolating operation based on a relative positional relationship between a position of the original pixel and the specific pixel arranged at the predetermined position, and the pixel data of the plural pixels arranged at the predetermined positions and acquired in the first processing.

25. The image processing apparatus of claim 23, wherein a storing capacity of each of the storing areas in a unit of one block is set at a size that is greater than a unit of the plural pixels to be employed in the interpolation processing.

26. The image processing apparatus of claim 23, wherein, when the colors include colors to be employed for calculating Red (R), Green (G), and Blue (B), an operation for storing pixel data of the distortion-corrected pixels into the storage section is conducted in such a manner that pixel data of combinations of the colors to be employed for calculating R, G, and B is continuously conducted.

27. The image processing apparatus of claim 23, wherein the optical system comprises an optical system that is used for capturing a wide angle image.
